(19) United States
(12) Patent Application Publication
(10) Pub. No.: US 2024/0420280 A1
(43) Pub. Date: Dec. 19, 2024

(54) METHOD FOR PERFORMING TRANSPOSE CONVOLUTION OPERATIONS IN A NEURAL NETWORK

(71) Applicant: UNIVERSITY OF LOUISIANA LAFAYETTE, Lafayette, LA (US)

(72) Inventors: Vijay Srinivas TIDA, Lafayette, LA (US); Sonya Hsu, Lafayette, LA (US); Xiali Hei, Lafayette, LA (US); Sai Venkatesh Chilukoti, Lafayette, LA (US); Yazhou Tu, Lafayette, LA (US)

(21) Appl. No.: 18/744,260

(22) Filed: Jun. 14, 2024

Related U.S. Application Data
(60) Provisional application No. 63/521,273, filed on Jun. 15, 2023.

(51) Int. Cl. G06T 3/4046; G06T 7/73

(52) U.S. Cl. CPC G06T 3/4046; G06T 7/74; G06T 2207/20084

(57) ABSTRACT

An algorithmic-level optimization technique based on kernel segregation mechanisms for efficient transpose convolution implementation without requiring an upsampling layer. Experimental results showed that the proposed approach showed an average of 3.7×(3.4×) faster computation than conventional methods known in the art. The method further provides significant improvement in computation speed and substantial memory savings from the obtained results.

### CROSS-REFERENCE TO RELATED APPLICATIONS

This application claims priority to U.S. Provisional Application No. 63/521,273 titled “Method of Optimization of Transpose Convolution” filed on Jun. 15, 2023.

### STATEMENT REGARDING FEDERALLY SPONSORED RESEARCH OR DEVELOPMENT

Not applicable.

### FIELD OF THE INVENTION

The field of this invention relates to the field of neural network computer processing and, more particularly, methods for performing and supporting machine learning.

### BACKGROUND OF THE INVENTION

Deep Learning has shown promising results in computer vision, audio signal processing, and even natural language processing applications. The upsampling process helps increase the spatial resolution of the data while preserving the input data representation. In deep learning applications, the upsampling process helped with various tasks like producing high-resolution images, image segmentation, and is used to generate data samples for imbalanced data, etc.

Several upsampling methods under non-learning upsampling and learning-based upsampling techniques have been proposed by those skilled in the art. Non-learnable upsampling techniques like Nearest Neighbors, Bi-Linear Interpolation, Bicubic Interpolation, Bed of Nails, and max-unpooling methods are predefined and invariant on the data. The above techniques mentioned are task-specific, which means they do not learn any information from the input data. Inter-polation techniques pose additional problems like computational complexity, blurring results, and noise amplification. To overcome these problems learnable upsampling techniques like transpose convolution layer or deconvolution layer, sub-pixel layer and meta upscale module have been proposed by those skilled in the art. These techniques learn information from the given input data using learnable parameters. Among the learnable upsampling techniques, transpose convolution became the most popular scheme because of its usage in Generative Adversarial Networks (GANs).

Transposed convolutional layers are used in a variety of tasks, including image generation, image super-resolution, and image segmentation. They are particularly useful for tasks that involve upsampling the input data, such as converting a low-resolution image to a high-resolution one or generating an image from a set of noise vectors. The terms transpose convolution layer and deconvolution layer are used interchangeably in the art (this application will use the term transpose convolution layer, the term that is the standard usage in GANs). Transpose convolution with stride one will not be helpful in deep learning applications because of the checkerboard pattern. This problem arises due to more values accumulated at the center pixels. Therefore, transpose convolution is formed by combining upsampling and convolution layers are used to avoid the checkerboard problem. In this application, the inventors proposed the optimization technique for implementing the transpose convolution efficiently. The upsampling layer transforms the input feature map by embedding zeros after each input value along each row and each column, which results in nearly 4× larger than the original size as shown in FIG. 2 by ignoring padding.

GANS are generative models using in machine learning to create new data instances that resemble a user's training data. GANs consist of two parts, namely, generator (which learns to produced the target output) and discriminator (which learns to distinguish true data from the output of the generator). The generator learns to generate plausible data, and the generated instances become negative training examples for the discriminator. The discriminator learns to distinguish the generator's fake data from real data and penalizes the generator for producing implausible results. The transpose convolution layer is the major operation in the generator part, whereas convolution is the major operation in the discriminator part. The general overview of the convolution and transpose convolution is illustrated in FIG. 1. Suppose the input feature map of size N×N is taken along with the kernel size n×n, applying the convolution operation will reduce the dimension in the output feature map. Using different padding factors can change the input feature map's dimensions, which results in the output feature map's dimensions. The dimension of the output feature map will be (N−n+1)×(N−n+1). Transpose convolution uses an upsampled input feature map, which can be size (2N−1)×(2N−1). There will be an opposite process that will increase the size of the feature map instead of shrinking it. The dimension of the output feature map will be (2N−n)×(2N−n).

Transpose convolution is equivalent to the convolution operation, except the input feature map is in a different format that can be seen in FIG. 2. FIG. 2 explains the basic transpose convolution operation with the input feature map of size 4×4 and a kernel size of 3×3. In the upsampling layer, the input feature map is embedded with zeros in between the data values along each row and column. Zeros in the feature map make usage of this layer complicated due to the large input feature size, which can cause unnecessary data transfers, memory bottlenecks, and wastage of computing resources.

Prior research mainly focused on only designing the hardware accelerators for efficient convolution computation. Unfortunately, the usage of hardware accelerators might not be practical for transpose convolution implementation. Further, such implementations require extra hardware, and some need upsampling layers for efficient transpose convolution and implementation.

The convolution layer plays a significant role in deep learning applications. This layer computation can be done by sliding the kernel through the input feature map under given conditions like padding and striding. The formula for calculating the output feature map value using convolution operation for the 2D array is expressed in Equation 1 below:

$$out [ i , j ] = {\sum }_{u = 1}^{n} {\sum }_{υ = 1}^{n} in [ i + u ] [ j + υ ] \text{?} k [ u ] [ υ ] , \qquad ( 1 )$$

$$\text{?} \text{indicates text missing or illegible when filed}$$

where the array out represents the output feature map values of dimension (N−n+1)×(N−n+1), the array in represents the input feature map values of size N× N and k represents the kernel of size n×n. The element out [i, j] denotes the value of the output feature map located at i^{th} row and j^{th} column. The variable in [i+u][j+v] represents the value of the input feature map located at (i+u)^{th} row and (j+v)^{th} column and k[u][v] represents the value of the kernel at u^{th} row and w^{th} column. The same equation is applicable for transpose convolution, but the input dimension will be (2N−1)×(2N−1). The dimension of the input feature map for the transpose convolution will include only embedded zeros between the data values in the feature map without padding. In the embodiment herein we utilize a padding size of 2, striding of 1, to demonstrate the design. For evaluating the novel optimized model, we used padding size of n−1 for a kernel of size n×n with striding 1 on data obtained after upsampling layer.

Implementation of direct convolution using four nested loops can be expressed in the following Process 1:

$$for ( i = 0 ; i < N - n + 1 ; ++ i )$$

$$for ( j = 0 \text{?} j < N - n + 1 \text{?} ++ j )$$

$$out [ i ] [ j ] = 0$$

$$for ( u = 0 ; u < n ; ++ u )$$

$$for ( v = 0 ; v < n ; ++ v )$$

$$out [ i ] [ j ] \text{?} = in [ i + u ] [ j + v ] \text{?} k [ u ] [ v ] \vert$$

$$\text{?} \text{indicates text missing or illegible when filed}$$

The direct convolutional algorithm can be expressed in four loops based on one input feature map, and one kernel for one output feature map can be seen in Process 1. However, these inner loops increase based on batch size, input channels, output channels, and depth of the kernels. This implementation is better as it requires less memory, but on the other hand, computation will be slower. The significant advantage of this algorithm for training deep learning models is that it can implement a backpropagation algorithm with ease for all the cases when compared to other advanced approaches.

For computation tasks, multiplications are considered a basic overhead. However, as convolution operation involves more multiplications, reducing the multiplication count will benefit faster computation. Those skilled in the art have proposed to reduce computation costs by reducing the multiplications required for convolution—namely the Cook-Toom algorithm, Modified Cook-Toom algorithm, Winograd Algorithm, Modified Winograd algorithm, Iterated Convolution, Cyclic convolution, Fast Convolution algorithm by inspection etc. Later, others have proposed GEMM-based algorithms using computations in the convolution operator as a General Matrix Multiplication. Those used highly optimized Basic Linear Algebra Subprograms (BLAS) for convolution implementation. These algorithms rely on im2col or im2row transformation by converting convolution problems to GEMM-based formulation. Many deep learning frameworks including Tensorflow, PyTorch, and Caffe use a GEMM based algorithm. However, this algorithm needs patch matrices that require more memory storage and bandwidth.

Others skilled in the art have used smaller patches for computing convolution to reduce the memory overhead. Others employed fast convolution algorithms that use Fourier or Winograd transformation. However, fast convolution algorithms will give algorithmic speedup for specific convolution parameters like large kernel sizes, unit stride and dilation, sufficiently large input size, and many input and output channels. Therefore, these algorithms will not be the default option for deep learning applications with less kernel sizes. An indirect convolution algorithm was also proposed that eliminates expensive and memory-intensive im2col transformations and also replaces the im2col buffer with a much smaller indirection buffer. However, this algorithm can be applied for the forward propagation of the deep learning model but cannot be applied for the backward propagation of convolution layers.

Some skilled in the art proposed a parallel convolution algorithm and showed its performance on multi-core CPUs. They also discussed the disadvantages of im2col+GEMM in terms of high memory space usage, and showed that memory packings on the convolution are not memory-efficient. The performance evaluation shows a factor ranging from 1.0 to 5.17× than GEMM-based implementation. Others used a separable convolution operation in which the 2D kernel transformed into the row, and column kernels for mobile and embedded platforms. In that case the convolution operation is performed first using the row kernel, and then convolution is applied using the column kernel on the obtained intermediate feature map. However, using the same optimized algorithms directly for transpose convolution operation might not be efficient. The large input feature map of nearly 50% zeros results in the wastage of memory bandwidth for transferring data and memory usage due to the filling of unnecessary zeros. Later, unnecessary computations also exist due to zeros at the fixed positions in the input feature map.

Popular deep learning frameworks will use one of the optimized convolution algorithms in the background based on the input feature maps and kernel sizes. However, any optimized convolution algorithm can be applied to the novel approach described herein individually because the novel optimization technique involves four convolution operations.

Hardware accelerators have ben proposed in the art. Different conventional hardware accelerators were designed for effective convolution operation using Application-Specific Integrated Circuits (ASIC), Field Programmable Field Arrays (FPGA), etc. Some have become more popular architecture because of their faster speed and specific design for deep learning applications. Data movement between on-chip and off-chip consumes more power than computation. These accelerators achieved higher performance by minimizing the data movement energy cost by using row stationary (RS) on a spatial architecture with 168 processing elements. Later and advanced version of Eyeriss accelerator Eyeriss v2 was also proposed. Results showed that 12.6× faster and 2.5× more energy efficient by running Mobile Net model when compared to the original Eyeriss hardware accelerator. But conventional convolutional accelerators are inefficient for transpose convolution applications. Therefore, later hardware accelerators for efficient transpose convolution operation have been proposed.

Some skilled in the art designed a hardware accelerator for transpose convolution by rearranging the output and filter rows. The proposed hardware accelerator needs unification of Single Instruction Multiple Data (SIMD) and Multiple Instruction Multiple Data (MIMD) architectures. Results showed that the proposed accelerator showed 3.6× average speed up and 3.1× energy reduction for generative deep learning models compared to Eyeriss hardware accelerator performance. Those skilled in the art also designed an advanced version using Field Programmable Field arrays. Results showed 2.2× higher performance when compared to the optimized conventional accelerator and 2.6× better than Titan×GPU. Efficient implementation of transpose convolution was made using systolic arrays. The main disadvantages of these approaches are they need to use upsampled layer obtained from the input feature map and dedicated hardware for efficient transpose convolution implementation.

Additional known deep learning models rapidly increase the depth of the network, leading to exponential growth in computation load. Per Moore's law, the hardware resources might not be sufficient if the computation load grows exponentially. Therefore, there is a need for sparsification and pruning of deep learning networks. These techniques help to reduce the computation cost. A deep learning network involves many layers, with most information residing in 5 to 20% of neurons. By considering this, certain compressing deep neural networks have been proposed in the art. These models help train deep learning on the Internet of Things devices as the computation requirement is reduced significantly because of certain techniques such as channel pruning, filter pruning, structure pruning, etc. were proposed for deep convolutional networks. In the proposed method, there is no limitation to apply any pruning technique for the disclosed approach to the conventional network.

### SUMMARY OF THE INVENTION

Transpose convolution has shown prominence in many deep learning applications. Transpose convolution layers are computationally intensive due to the increased feature map size obtained after adding zeros after each element along each row and column. Thus, convolution operation on the expanded input feature map leads to poor utilization of hardware resources. The main reason for unnecessary multiplication operations is zeros at predefined positions in the input feature map.

Disclosed herein is a method for transpose convolution implementation designed to avoid problems that exist with known convolution processes. Based on kernel activations, the disclosed method may segregate the original kernel into four sub-kernels, which may reduce memory requirements and unnecessary multiplications. Experimental results show that the disclosed method results in 3.09(3.02)× faster computation. Furthermore, the proposed method can be modified to fit existing devices without additional hardware requirements. A simple deep learning model containing one transpose convolution layer is used to evaluate our optimization method for deep learning applications and showed 2.2× faster in training using MNIST data-set with Intel Duo Core CPU. Computation units for conventional and optimized approaches are implemented using 45 nm technology Synopsys Design Compiler. Results show that our proposed method substantially saves more area and shorter delay related to increasing the kernel size but will increase power consumption producing four output values. A 3×3/5×5 kernel requires almost 400/7,240 fewer cell units and 0.22/0.25 ns shorter delay but consumes nearly 0.7/3 mW more power consumption.

### BRIEF DESCRIPTION OF THE DRAWINGS

The drawings constitute a part of this specification and include exemplary embodiments of the METHOD FOR PERFORMING TRANSPOSE CONVOLUTION OPERATIONS IN A NEURAL NETWORK, which may be embodied in various forms. It is to be understood that in some instances, various aspects of the invention may be shown exaggerated or enlarged to facilitate an understanding of the invention. Therefore, the drawings may not be to scale.

FIG. 1 depicts a general overview of the conventional convolution and transpose convolution operations on an input feature map as currently known in the art.

FIG. 2 depicts an example transpose convolution by conventional convolution method known in the art with upsampled layer and kernel size of 3×3.

FIG. 3(a) is a rendering of an input feature map after an unsampling process where only a combination of even rows and even column elements from the original kernel are in the active state and others are inactive. The Pattern B sections indicate the zero values in the input, and the Pattern D sections indicate the position where kernel elements are effective. a), b), c), and d) parts show the computation pattern, continuing throughout the input feature map. There will be four cases in which the kernel can be segregated into four sub-kernels. Here, the inventors took the kernel size of 5×5 and input a feature map of size 4×4 for illustration purposes.

FIG. 3(b) is a rendering of an input feature map after an unsampling process where only a combination of even row and odd column element operations form the original kernal are in the active state, and all other element positions are useless.

FIG. 3(c) is a rendering of an input feature map after an unsampling process where only a combination of odd row and even column elements are used for computation and others remain unused.

FIG. 3(d) is a rendering of an input feature map after an unsampling process where only a combination of odd row and odd column elements is necessary, while the others remain unnecessary.

FIG. 4 is a rendering of the original 5×5 being divided into 4 sub-kernels of sizes 3×3, 3×2, 2×3, and 2×2. The four sub-kernels are formed by accessing the corresponding locations from the original kernel K.

FIG. 5(a) represents the input feature map of size 4×4 embedded with zeros, and a padding factor of 2 applied. When a kernel is sliding through the input feature map, its corresponding output values are calculated in the output feature map sequentially.

FIG. 5(b) applies the optimized transpose convolution where the four values of the output feature map are obtained from the four sub-kernels, where convolution operation is performed on the input feature map with the disclosed kernel segregation mechanism.

FIG. 6 is a flowchart representing the single computational convolution unit needed for an original transpose convolution.

FIG. 7 is a flowchart representing the four computation convolution units needed for the proposed optimization technique.

FIG. 8 is a model of the optimized transpose convolution implementation using four sub-kernels with input size 4×4 and padding with factor 1 (but padding factor is 2 for the original case). The darker boxes on the transpose convoluted output bottom and right size indicate the unwanted elements needed to be checked when optimization is performed.

FIG. 9 is a model of the optimized transpose convolution implementation using four sub-kernels with input size 4×4 and padding with factor 1 (but padding factor for 3 for original case).

FIG. 10 is a table of the speedup for graphics processing unit (GPU) and central processing unit (CPU) versions and memory savings obtained for Flower dataset for the conventional (Conv) and the proposed (Prop) approaches.

FIG. 11 is a table of the speedup for GPU and CPU versions for MSCOCO and PASCAL datasets using conventional (Conv) and proposed (Prop) approaches.

FIG. 12 is a table of the speedup for GPU and CPU versions and memory savings obtained from transpose convolution layers for popular GAN models.

FIG. 13 is a table of the number of floating-point operations like multiplications and additions required for the conventional and proposed methods.

FIG. 14 is a table of the synthesis results of the conventional and proposed methods using 45 nm and 14 nm technologies with three different integer kernels.

FIG. 15 is a table of the simple deep learning model configuration along with the total number of neurons for the MNIST dataset.

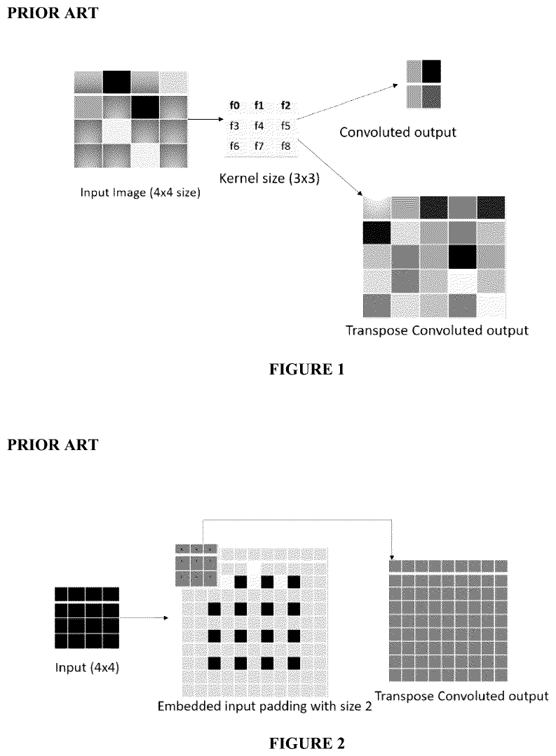

### DETAILED DESCRIPTION OF THE INVENTION

The novel approach disclosed herein is to introduce a method for optimizing transpose convolution. The optimized transpose convolution method uses a kernel segregation mechanism to reduce computational load and memory requirements without the need for specialized hardware by avoiding an upsampling layer. In studying the advantages of the proposed optimized method, the transpose convolution layers from popular GANs have been taken into consideration. The experimental results reveal a significant improvement in computation time without requiring an upsampling layer.

The significant contribution of this work is reducing the computation load for transpose convolution using the kernel segregation mechanism, with no need for upsampled input feature map. Also, the approach disclosed herein will reduce the memory requirement for running the model to half compared to conventional transpose convolution layer implementation. Additionally, the number of multiplications required will be reduced drastically when compared to the conventional implementation. The proposed optimization method has capability to produce four output values instead of one using the conventional method. Unlike previous approaches, the disclosed optimization approach does not use the dedicated hardware accelerator, especially for the efficient transpose convolution implementation.

Furthermore, a single transpose convolution layer was used to evaluate the novel optimization method on a simple deep learning model using the MNIST dataset. Testing results showed the training is 2.2× faster when compared to naive transpose convolution implementation. Moreover, the novel optimization process can be extended further to existing optimized convolution algorithms on the top level since it uses four separate convolutions on the same input feature map. Computation unit for conventional and proposed optimization method was evaluated using 45 nm Synopsys Design Compiler with the help of Verilog language. Results show that the proposed optimization technique, which produces four output values, needs less area and lower delay but needs more power consumption.

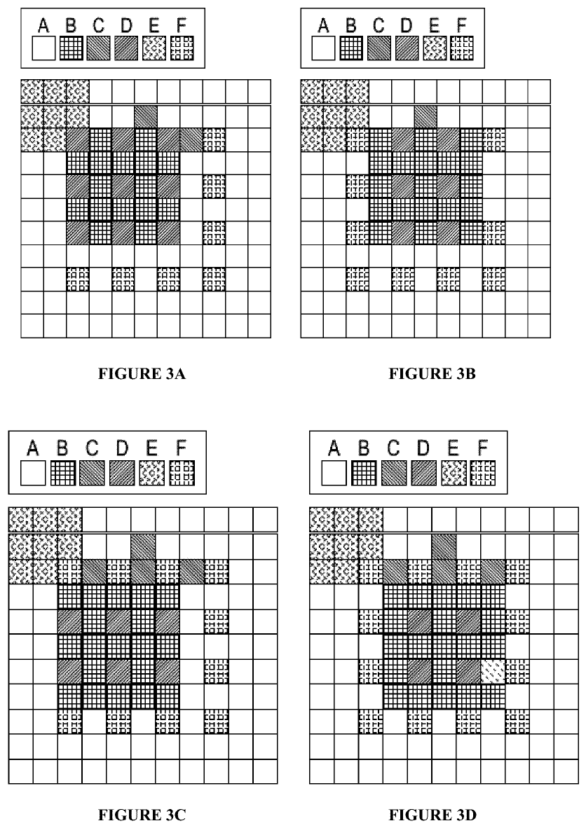

Methodology. The disclosed method may involve segregating the original kernel into four subkernals based on the unsampled input feature map pattern. Because the zeros may be embedded along each row and column after every element in a predefined manner, as shown in FIG. 3, four common cases may arise when the original kernel is sliding through the input feature map. The Pattern B sections indicate that the values may be zeros in the corresponding input feature map. The kernel elements may be inactive at these positions and need to be discarded. An inactive state means that the multiplication operations may give zero at the related positions. The Pattern D sections indicate that the values are non-zero in the corresponding input feature map. The kernel elements may be in the active states, which needed to be considered for the segregation mechanism disclosed herein. An active state means that the multiplication operation is effective in these spots.

In one embodiment, assume that the indexing of elements starts at (0,0) on the input feature map. In a first case as shown in FIG. 3(a), only a combination of even row and even column elements from the original kernel are in the active state, and other elements are inactive. In another case as seen in FIG. 3(b), only a combination of even row and odd column elements operation from the original kernel are in the active state, and all other element positions are inapplicable. In a third case as seen in FIG. 3(c), only a combination of odd row and even column elements are helpful, and others remain inapplicable. Similarly, for a fourth case as seen in FIG. 3(d), only a combination of odd row and odd column elements are useful, and others remain useless. If four cases are appropriately analyzed, four convolution operations may be performed indirectly on the same input feature map. This significant observation will helps perform the optimization method using kernel segregation. There will be some offsets based on a particular activation set, which will be reviewed subsequently.

The kernel segregation mechanism can be applied to any odd kernel size of N×N. The general matrix representation of the four sub-kernals may be obtained from Equations 3, 4, 5, and 6, respectively from the original kernel size of N×N. The four sub-kernels K₁, K₂, K₃, K₄ are formed by accessing the corresponding locations from the original kernel K.

$$K = [ \begin{matrix}{k}_{00} & {k}_{01} & {k}_{02} & … & {k}_{0 ( N - 1 )} \\ {k}_{10} & {k}_{11} & {k}_{12} & … & {k}_{1 ( N - 1 )} \\ {k}_{20} & {k}_{21} & {k}_{22} & … & {k}_{2 ( N - 1 )} \\ {k}_{30} & {k}_{31} & {k}_{32} & … & {k}_{3 ( N - 1 )} \\ ⋮ & ⋮ & … & … & ⋮ \\ ⋮ & ⋮ & … & … & ⋮ \\ ⋮ & ⋮ & … & … & ⋮ \\ {k}_{( N - 1 ) 0} & {k}_{( N - 1 ) 1} & {k}_{( N - 1 ) 2} & … & {k}_{0 ( N - 1 ) ( N - 1 )}\end{matrix} ] \qquad ( 2 )$$

$${K}_{00} = [ \begin{matrix}{k}_{01} & {k}_{02} & … & {k}_{0 ( N - 1 )} \\ {k}_{21} & {k}_{22} & … & {k}_{2 ( N - 1 )} \\ ⋮ & ⋮ & ⋱ & ⋮ \\ {k}_{( N - 1 ) 0} & {k}_{( N - 1 ) 2} & … & {k}_{( N - 1 ) ( N - 1 )}\end{matrix} ] \qquad ( 3 )$$

$${K}_{01} = [ \begin{matrix}{k}_{01} & {k}_{03} & … & {k}_{0 ( N - 2 )} \\ {k}_{21} & {k}_{23} & … & {k}_{2 ( N - 2 )} \\ ⋮ & ⋮ & ⋱ & ⋮ \\ {k}_{( N - 1 ) 1} & {k}_{( N - 1 ) 3} & … & {k}_{( N - 1 ) ( N - 2 )}\end{matrix} ] \qquad ( 4 )$$

$${K}_{10} = [ \begin{matrix}{k}_{10} & {k}_{12} & … & {k}_{1 ( N - 1 )} \\ {k}_{30} & {k}_{32} & … & {k}_{3 ( N - 1 )} \\ ⋮ & ⋮ & ⋱ & ⋮ \\ {k}_{( N - 2 ) 0} & {k}_{( N - 2 ) 2} & … & {k}_{( N - 2 ) ( N - 1 )}\end{matrix} ] \qquad ( 5 )$$

$${K}_{11} = [ \begin{matrix}{k}_{11} & {k}_{13} & … & {k}_{1 ( N - 2 )} \\ {k}_{31} & {k}_{33} & … & {k}_{3 ( N - 2 )} \\ ⋮ & ⋮ & ⋱ & ⋮ \\ {k}_{( N - 2 ) 1} & {k}_{( N - 2 ) 3} & … & {k}_{( N - 2 ) ( N - 2 )}\end{matrix} ] \qquad ( 6 )$$

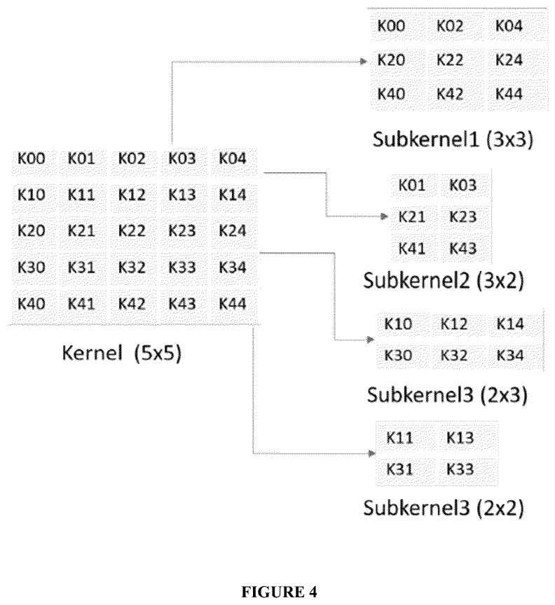

To obtain the first sub-kernel K₁, the values along the alternate columns and alternate rows, which starts from (0,0)^{th} element are stored from the original kernel K. Similarly, the remaining three sub-kernels K₂, K₃, K₄ are also obtained by starting with (0,1)^{th}, (1,0)^{th}, and (1,1)^{th} elements of the original kernel K, respectively. These four sub-kernels will help perform the four convolution operations on the given input feature map based on the patch of the data taken at each time. The final sizes of four sub-kernels will be ┌N/2┐>┌N/2┐, ┌N/2┐×┌N/2┐, ┌N/2┐×┌N/2┐, and ┌N/2┐>┌N┐ respectively. N₁₁×N₁₂, N₂₁×N₂₂, N₃₁×N₃₂, and N₄₁×N₄₂ are used as sizes for four segregated kernels. Here ┌·┐ represents the ceiling function and └·┘ represents the floor function. However, the arrangement of elements will vary if an even ordered kernel is used and still follows the same process. Separating out the original kernel into sub-kernels can be seen in FIG. 4.

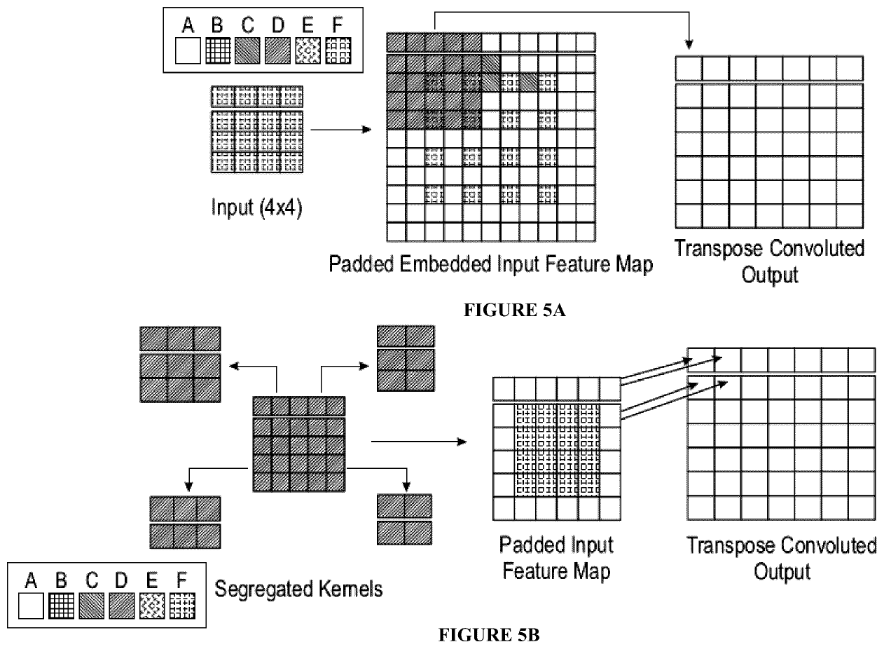

The conventional transpose convolution and proposed optimized transpose convolution can be seen in FIG. 5. FIG. 5(a) represents the input feature map of size 4×4 embedded with zeros, and a padding factor of 2 is applied. When a kernel is sliding through the input feature map, its corresponding output values are calculated in the output feature map sequentially. As seen in FIG. 5(b), the four values of the output feature map are obtained from the four sub-kernels, when convolution operation is performed on the input feature map with the proposed kernel segregation mechanism. Also, the padding factor for the input feature using four segregated kernels will be different from the original padding factor. For example, suppose the original padding factor is P, the new padding factor will be └P/2┘. Additionally, if the original padding factor is odd, the algorithms need to interchange the new set of four sub-kernels like K₄, K₃, K₂, and K/instead of K₁, K₂, K₃, and K₄.

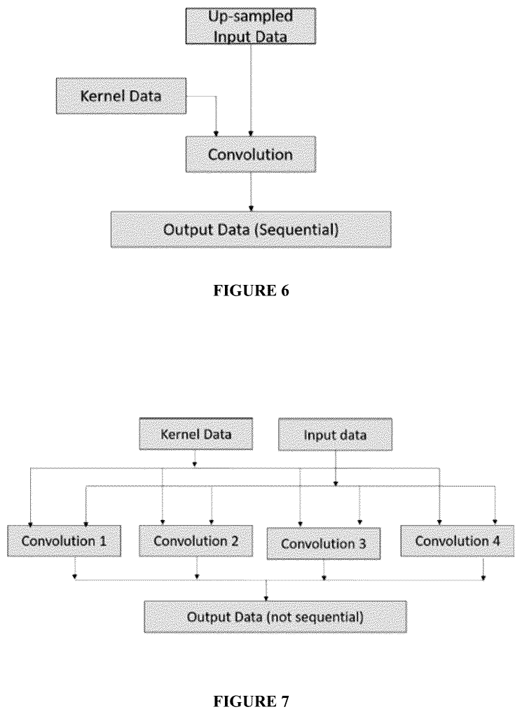

FIG. 6 represents the actual conventional transpose convolution operation that takes unsampled input data and kernel data for each pass to perform the convolution operation. In the conventional approach, only one computation unit is needed to perform convolution operation and the values are needed to be written in the output feature map successively. As seen then in FIG. 7, the proposed methodology needs four convolution units instead of one to perform the transpose convolution. Here the input data is almost identical, and it is not an unsampled version as compared to the conventional approach. As a result, the values will not be sequentially written in the output feature map using this disclosed approach.

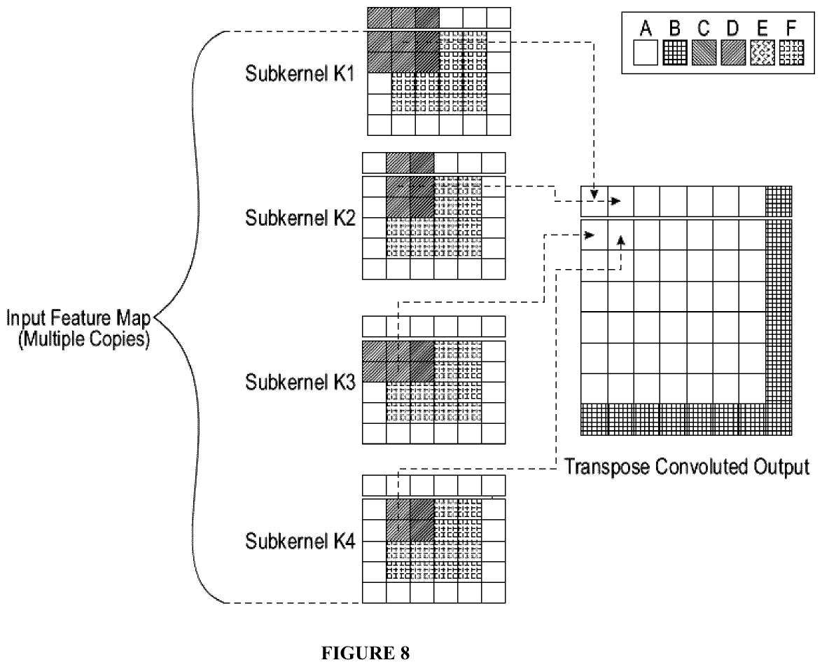

FIG. 8 further illustrates the process of the proposed optimized transpose convolution operation using the kernel segregation mechanism applied on an input feature map of size 4×4. Here the padding factor for the input feature map is reduced to 1 from 2 to obtain the exact output feature map from the transpose convolution operation. Next, the convolution operation is applied on the same padded input feature map with four sub-kernels to produce four output values at different locations. After the four sub-kernels are slid through the input feature map, the regular convolution operations write the output results at four specified locations. Predefined offsets will help obtain these four specified outpost locations. The first two output locations and the last two output locations are adjacent to each other but on different rows of the output feature map. On the other hand, one can get the position for the second pair by adding a specific constant from the place of the first pair.

The output feature mat will move successively when the regular convolution operation is applied. But in the proposed optimization technique, the values in the output feature map are located at four different positions when the four convolutions are applied. The offsets are calculated as the positions at the output feature map for each patch of input data are loaded. The optimized transpose convolution operation should show four times faster for the ideal case compared to the conventional approach with the same computation load. However, due to the offset problem related to computation in finding specific output locations, there might be some reduction in performance without considering padding and zero embedded time. If the output feature map is of an odd dimension, this continuous process will result in an extra column and row, as indicated in FIG. 5. The main reason for the problem is that the optimized algorithm will produce four output feature values in each iteration. The conditional statements can avoid unnecessary computation based on the user requirements. The formulas for calculating the four output feature values by applying the optimization process can be seen in the Equations 7, 8, 9, and 10.

$$out [ 2 * i ] [ 2 * j ] = {\sum }_{u = 1}^{{N}_{11}} {\sum }_{υ = 1}^{{N}_{12}} in [ i + u ] [ j + υ ] * {K}_{1} [ u ] [ υ ] , \qquad ( 7 )$$

$$out [ 2 * i ] [ 2 * j + 1 ] = {\sum }_{u = 1}^{{N}_{21}} {\sum }_{υ = 1}^{{N}_{22}} in [ i + u ] [ ( j + 1 ) + υ ] * {K}_{2} [ u ] [ υ ] , \qquad ( 8 )$$

$$out [ 2 * i + 1 ] [ 2 * j ] = {\sum }_{u = 1}^{{N}_{31}} {\sum }_{υ = 1}^{{N}_{32}} in [ ( i + 1 ) + u ] [ j + υ ] * {K}_{3} [ u ] [ υ ] , \qquad ( 9 )$$

$$out [ 2 * i + 1 ] [ 2 * j + 1 ] = {\sum }_{u = 1}^{{N}_{41}} {\sum }_{υ = 1}^{{N}_{42}} in [ ( i + 1 ) + u ] [ ( j + 1 ) + υ ] * {K}_{4} [ u ] [ υ ] , \qquad ( 10 )$$

where out[I][m] represents the output feature map located at the I^{th} row and m^{th} column; in [i][j] represents the input feature map at the corresponding i^{th} row and j^{th} column; K₁[u][v], K₂[u][v], K₃ [u][v], and K₄[u][v] represents the sub-kernels K₁, K₂, K₃, and K₄ obtained after segregation mechanism and their locations at uth row and vth row. The sizes of the corresponding four sub-kernels will be N₁₁×N₁₂, N₂₁×N₂₂, N₃₁×N₃₂, and N₄₁×N₄₂. Here, the size of the input feature map will remain the same without upsampled values. The individual output feature map's dimensions depend on the size of the sub-kernels. Finally, the output feature map obtained from the proposed optimization should ensure the same dimensions when conventional transpose convolution is applied. If there are more output values than required, we should discard them.

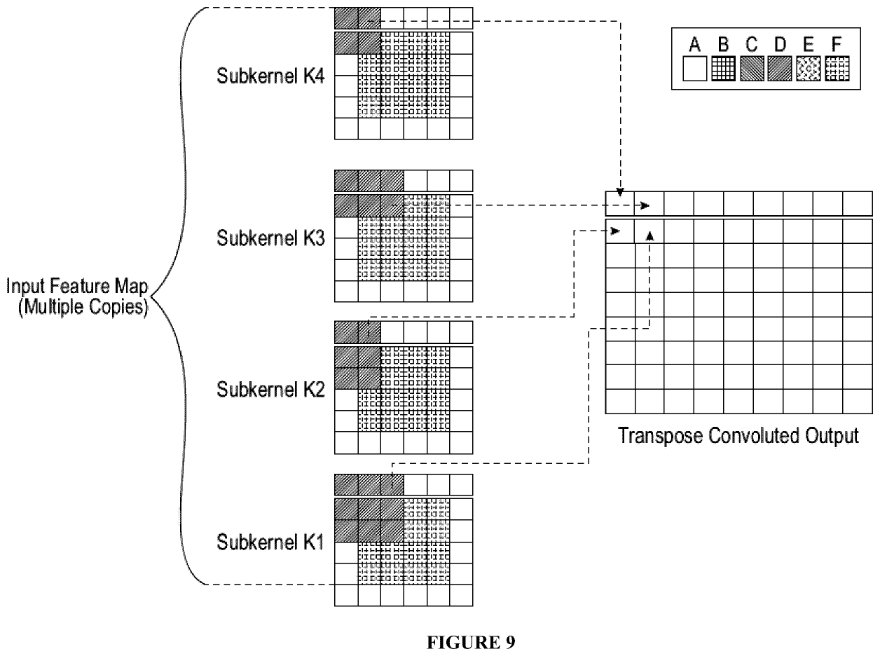

FIG. 9 shows the proposed optimization technique when the padding factor is odd, and the kernel size of 5×5 is applied on the input feature map. The new padding factor for the input feature map will be one instead of three in the original case to apply the proposed optimization technique. The four convolution operations are performed on the same input feature map. The above exact process and the equations will still hold here, but the order of sub-kernels will change when the four convolution operations are made on the input feature map. In this case, the odd padding factor reverses the order of sub-kernels compared to the prior case. The new set of sub-kernels will be K₄, K₃, K₂, and K₁ instead of K₁, K₂, K₃, and K₄ for this case. In deep learning applications, the proposed optimization technique can be used to calculate the kernel and input gradients during the backwards propagation process. Since the proposed approach combines the unsampling and convolution layers, there will be a significant advantage in avoiding unnecessary input gradient computations.

Optimized convolution algorithms may not suit the backpropogation process in training a deep learning model. The main reason is that the complicated computation process is needed to perform convolution. The optimized convolution algorithms are suited only for specific cases based on input feature map size, kernel size, etc. The naïve convolution approach can be applied to forward and backward propagation with restriction without restrictions for all cases. In the proposed optimization method, the naïve convolution approached is used with minor modifications. The modifications include accessing the input and output data at predefined locations during the forward propagation. The same proposed method can be used in backward propagation to calculate the gradient for the kernels and input data. In the disclosed approach, the method combines upsampled layer and convolutional layer into one layer.

Methodology Evaluation. The flower dataset was used from the Kaggle website, MSCOCO 2017, and PASCAL VOC 2012 datasets to compare the computation times and memory savings for the conventional and proposed optimized approaches for transpose convolution operation. The flower data set contains five subgroups of classes, namely sunflower, dandelion, daisy, rose, and tulip. The total number of images in this dataset was 4,323; among them sunflower class contains 734; the tulip class includes 984; the daisy class contains 769; the rose class contains 784; and the dandelion class contains 1,052 color images. The present experiment considered only 10% of the available images, 11,828 from the MSCOCO 2017 data set for the experimental analysis. Also, for the PASCAL 2017 dataset, testing used both classification and segmentation datasets. The classification dataset contains 17,125 images, whereas the segmentation dataset contains 2,913 images of various sizes. For standard evaluation, all the images from the selected datasets are transformed into a standard format of 224×224×3. The experiment applies transpose convolution to the images and assessed the computation time using conventional and the proposed methods. The programming languages used are C++ and CUDA C for the CPU and GPU, respectively. The computation time and memory requirements are considered for evaluating the benefits of the proposed approach with the conventional implementation.

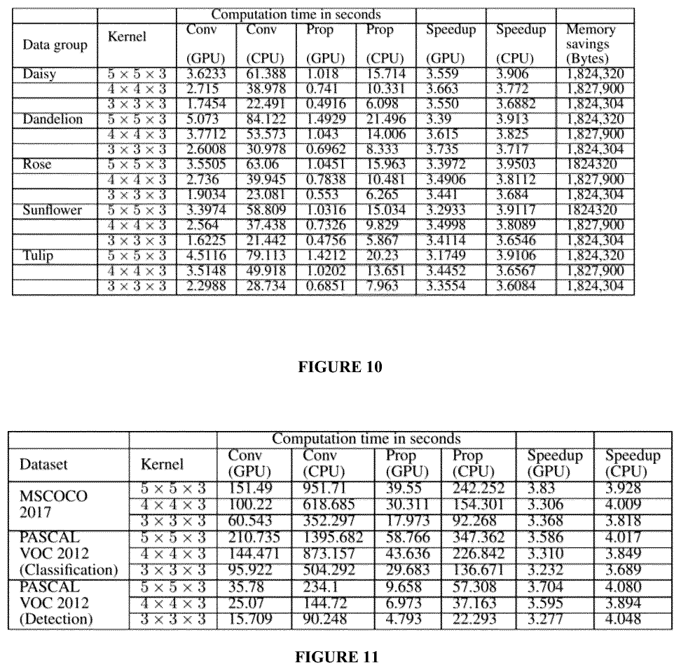

Compared to the conventional approach, speedup, and memory savings from the proposed optimization process with the selected datasets can be seen in the tables in FIGS. 10 and 11. The experiment varied the kernel size of 5×5, 4×4, and 3×3 to apply the transpose convolution operation for the input dimension of 224×224×3. Reported are the flower dataset's computation time and memory savings obtained from both approaches. The results show that the sub-classes of the flower dataset reached 3.4×(3.7×) speedup on average for GPU (CPU), with memory savings above 11,824,304 bytes based on kernel size. Similarly, the average speedup of 3.4×(3.8×) for GPU (CPU) was achieved for the MSCOCO 2017 and PASCAL VOC 2012 datasets. Since all the input images for these datasets are preprocessed into the exact size of 224×224×3, the memory savings still holds the same for these datasets from FIG. 10.

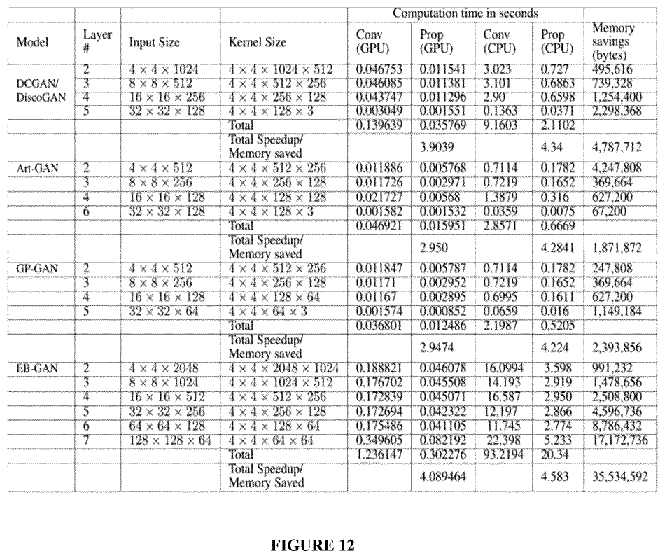

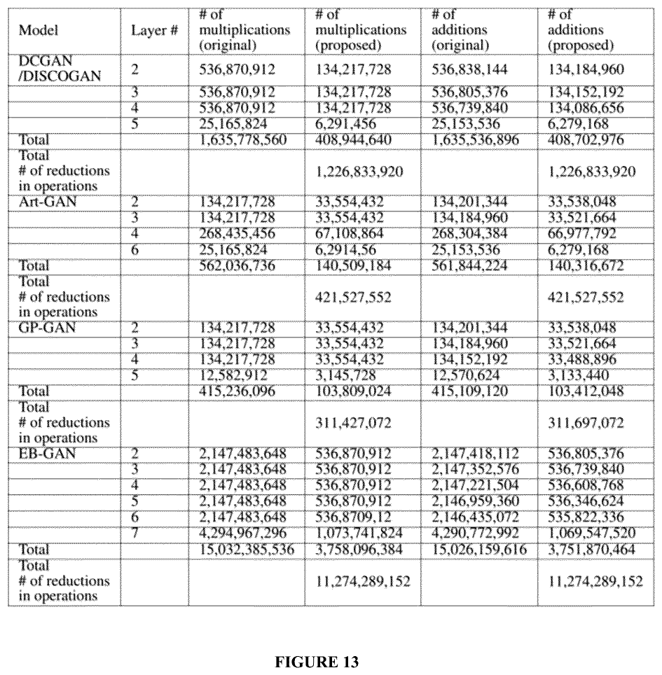

The computation times were calculated using NVIDIA TITAN×GPU and Intel Core-2 Duo CPU for various conditions are noted in FIGS. 12 and 13. The conditions include integer value, a floating-point value that uses 5×5 and 3×3 kernel sizes. The computation times are noted for each class in the flower dataset when applied naive transpose convolution and proposed optimization methods. Here the original padding factor used for 3×3 is two, and 5×5 kernel is four. The computation time for the floating-point kernels of size 3×3 showed 3.08×; and the size of 5×5 showed 3.19× faster than conventional convolutional algorithm using GPU. For an integer kernels, size of 3×3 showed 3.14×, and size of 5×5 showed 3.15× faster than conventional convolution implementation. The speedup is significantly improved with the increase in the kernel sizes for all three datasets, with the corresponding memory savings. However, the even order kernel showed more memory savings because it didn't produce offset elements during computation.

The computation time, memory savings, and computation load for the transpose convolution layers commonly used in the popular GAN architectures are reported in FIGS. 12 and 13. The forward propagation phase for the layers is only considered by taking only one input sample during experimental analysis. In the DC-GAN/DiscoGAN, the average speedup of 3.9× (4.34×) was achieved for GPU (CPU) from the proposed approach with the overall memory savings of 4,787,712 bytes from the transpose convolution layers. Similarly, Art-GAN and GP-GAN had an average speedup of 2.95×(4.2×) for GPU (CPU). EB-GAN model showed the highest speedup of 4.08×(4.583×) because of more computation load needed for the transpose convolution layers in the model. We obtained limited GPU speedup for Art-GAN and GP-GAN models since the number of floating point operations like multiplications and additions is relatively less than in other models, which results in lower memory transfers. Among all the analyzed models, EB-GAN showed the highest memory savings in bytes of 35,534,592 from all transpose convolution layers. Additionally, there will be considerable improvement in the speedup from the transpose convolution layers during the training process, especially from backward propagation.

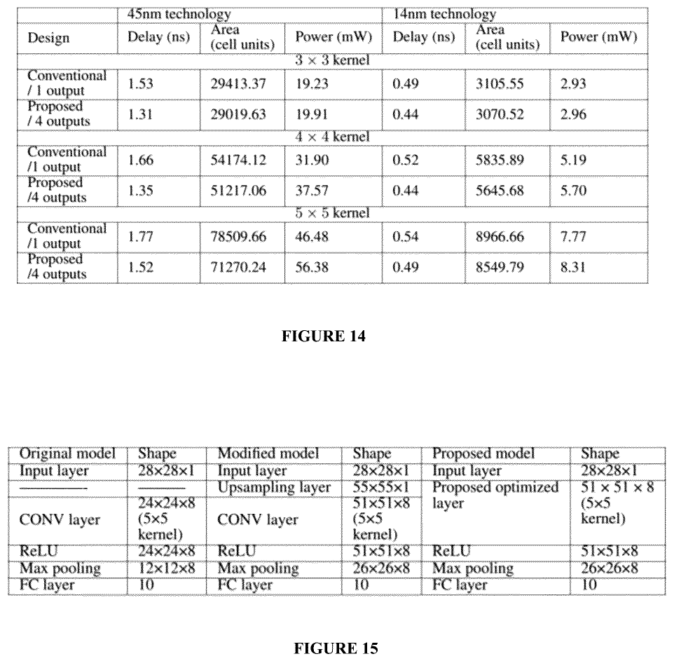

The functional unit for the transpose convolution operation is implemented using the Verilog language to understand the hardware characteristics for the conventional and proposed optimization methods, as depicted in FIG. 14. Here, Synopsys DC Compiler with 45 nm and 14 nm technology is used to analyze the original and proposed methods' performance using integer kernels of 32 bits with an input size of 8 bits. Results indicate that the proposed model requires more power but less delay and area than the conventional implementation. However, the power consumption for the proposed method is higher because it writes four output values instead of one, compared to the conventional implementation.

Evaluated here is the training time using a simple convolutional neural network model for practical application in deep learning to illustrate the advantage of the proposed optimization. The model design having one convolutional layer trained on the MNIST dataset) is considered for the analysis, and the model's structure can be seen in FIG. 15. It consists of an input layer with a shape of 28×28×1 followed by a convolutional layer (CONV layer) with a Rectified Linear Unit (ReLU) as an activation function and a max-pooling layer. Finally, a fully connected layer (FC layer) is added with ten neurons, as there are ten classes of MNIST images. Later, the convolutional layer is replaced with conventional and proposed transpose convolution layers to compare the training time for both models. The model was trained using Intel dual-core processor with all the layers implemented using C++. The training time is taken for the model when 100,000 epochs with a minibatch size of 1 for comparing the two models. The training time obtained for the original model was 1,100 seconds, whereas the proposed model took only 501 seconds. Results showed that our proposed optimized algorithm performed 2.2× faster than the conventional approach.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

In the foregoing description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure. Such changes and modifications are to be understood as being included within the scope of the disclosure and examples as defined by the claims.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

The present invention also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention, as described herein.
The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

We claim:

1. A method of performing transpose convolution on an input image in a neural network, comprising:
a. providing an input image to be processed;
b. providing a generative adversarial network in the neural network comprising a transpose convolution layer, comprising one or more upsampling layers and one or more convolution layers;
c. generating an input feature map from the input image, wherein the input feature map four or more input values which are organized into a grid formation comprising two or more rows and two or more columns;
d. generating an original kernel based on an unsampled input feature map pattern, wherein the original kernel is a size of N×N;
e. identifying a padding factor of the original kernel;
f. from the original kernel, generating four sub-kernels, comprising K₁, K₂, K₃, and K₄, wherein each of the sub-kernels is of a size [N/2]×[N/2];
g. identifying a new padding factor, comprising half the size of the padding factor of the original kernel;
h. performing a convolution by sliding K₁ through the input feature map;
i. repeating the convolution step for each sub-kernel K₂, K₃, and K₄;
j. calculating a plurality of corresponding output values in an output feature map;
k. locating a plurality of values in the output feature map at four different positions; and
l. calculating each offset as the position at the output feature map for each patch of input data is loaded.

2. The method of claim 1, wherein a matrix representation of the original kernel can be obtained as follows:
$$K = [ \begin{matrix}{K}_{00} & {K}_{01} & {K}_{02} & … & {K}_{0 ( N - 1 )} & {K}_{0 N} \\ {K}_{10} & {K}_{11} & {K}_{12} & … & {K}_{1 ( N - 1 )} & {K}_{1 N} \\ {K}_{20} & {K}_{21} & {K}_{22} & … & {K}_{2 ( N - 1 )} & {K}_{2 N} \\ {K}_{30} & {K}_{31} & {K}_{32} & … & {K}_{3 ( N - 1 )} & {K}_{3 N} \\ ⋮ & ⋮ & … & … & ⋮ & ⋮ \\ ⋮ & ⋮ & … & … & ⋮ & ⋮ \\ ⋮ & ⋮ & … & … & ⋮ & ⋮ \\ {K}_{( N - 1 ) 0} & {K}_{( N - 1 ) 1} & {K}_{( N - 1 ) 2} & … & {K}_{( N - 1 ) ( N - 1 )} & {K}_{( N - 1 ) N} \\ {K}_{N 0} & {K}_{N 1} & {K}_{N 2} & … & {K}_{N ( N - 1 )} & {K}_{NN}\end{matrix} ]$$
wherein:
a. K represents each segment in the original kernel; and
b. N represents a size of the original kernel;

3. The method of claim 1, wherein a matrix representation of K₁ can be obtained as follows:
$${K}_{1} = [ \begin{matrix}{K}_{00} & {K}_{02} & … & {K}_{0 N} \\ {K}_{20} & {K}_{22} & … & {K}_{2 N} \\ ⋮ & ⋮ & ⋱ & ⋮ \\ {K}_{N 0} & {K}_{N 2} & … & {K}_{NN}\end{matrix} ]$$
wherein:
a. K represents each segment in K₁; and
b. N represents a size of K₁.

4. The method of claim 1, wherein a matrix representation of K₂ can be obtained as follows:
$${K}_{2} = [ \begin{matrix}{K}_{01} & {K}_{03} & … & {K}_{0 ( N - 1 )} \\ {K}_{21} & {K}_{23} & … & {K}_{2 ( N - 1 )} \\ ⋮ & ⋮ & ⋱ & ⋮ \\ {K}_{N 1} & {K}_{N 3} & … & {K}_{N ( N - 1 )}\end{matrix} ]$$
wherein:
a. K represents each segment in K₂; and
b. N represents a size of K₂.

5. The method of claim 1, wherein a matrix representation of K₃ can be obtained as follows:
$${K}_{2} = [ \begin{matrix}{K}_{01} & {K}_{03} & … & {K}_{0 ( N - 1 )} \\ {K}_{21} & {K}_{23} & … & {K}_{2 ( N - 1 )} \\ ⋮ & ⋮ & ⋱ & ⋮ \\ {K}_{N 1} & {K}_{N 3} & … & {K}_{N ( N - 1 )}\end{matrix} ]$$
wherein:
a. K represents each segment in K₃; and
b. N represents a size of K₃.

6. The method of claim 1, wherein a matrix representation of K₄ can be obtained as follows:
$${K}_{2} = [ \begin{matrix}{K}_{01} & {K}_{03} & … & {K}_{0 ( N - 1 )} \\ {K}_{21} & {K}_{23} & … & {K}_{2 ( N - 1 )} \\ ⋮ & ⋮ & ⋱ & ⋮ \\ {K}_{N 1} & {K}_{N 3} & … & {K}_{N ( N - 1 )}\end{matrix} ]$$
wherein:
a. K represents each segment in K₄; and
b. N represents a size of K₄.

7. The method of claim 1, wherein if the padding factor of the original kernel is odd, the four sub-kernels are reversed.

8. The method of claim 1, wherein each output feature value can be determined from one of a following equations:
$$a . out [ 2 * i ] [ 2 * j ] = {\sum }_{u = 1}^{{N}_{11}} {\sum }_{v = 1}^{{N}_{12}} in [ i + u ] [ j + v ] * {K}_{1} [ u ] [ v ] ;$$
$$b . out [ 2 * i ] [ 2 * j + 1 ] = {\sum }_{u = 1}^{{N}_{21}} {\sum }_{v = 1}^{{N}_{22}} in [ i + u ] [ ( j + 1 ) + v ] * {K}_{2} [ u ] [ v ] ;$$
$$c . out [ 2 * i + 1 ] [ 2 * j ] = {\sum }_{u = 1}^{{N}_{31}} {\sum }_{v = 1}^{32} in [ ( i + 1 ) + u ] [ j + v ] * {K}_{3} [ u ] [ v ] ;$$
$$and$$
$$d . out [ 2 * i + 1 ] [ 2 * j + 1 ] = {\sum }_{u = 1}^{{N}_{41}} {\sum }_{v = 1}^{{N}_{42}} in [ ( i + 1 ) + u ] [ ( j + 1 ) + v ] * {K}_{4} [ u ] [ v ] .$$
wherein:
a. out [I][m] represents the data value of the output feature map located at I^{th} row and m^{th} column;
b. in [i][j] represents the data value of the input feature map at the corresponding i^{th} row and j^{th} column; and
c. K₁[u][v], K₂[u][v], K₃[u][v], and K₄[u][v] represents the sub kernels K₁, K₂, K₃, and K₄, respectively, and respective locations at u^{th} row and w^{th} row.

9. The method of claim 1, wherein one or more dimensions of the output feature map depend on the sub-kernel's size.
